(19) United States
(12) Patent Application Publication
(10) Pub. No.: US 2018/0245570 A1
(43) Pub. Date: Aug. 30, 2018

(54) Novel Lubricating and Cooling System for Wind Power Generation Gear Box

(71) Applicant: Soliner (Nanjing) Intelligent Technology Co., Ltd., Nanjing (CN)

(72) Inventor: Guozhen ZHOU, Nanjing (CN)

(21) Appl. No.: 15/652,277

(22) Filed: Jul. 18, 2017

Related U.S. Application Data
(63) Continuation of application No. PCT/CN2017/074893, filed on Feb. 25, 2017.

(30) Foreign Application Priority Data
Jun. 16, 2017 (CN) 201610426786.2

(51) Int. Cl. F03D 80/70; F03D 80/60; F16H 57/04

(52) U.S. Cl. CPC F03D 80/70; F03D 80/60; F16H 57/0436; F05B 2260/4031; F16H 57/0404; F16H 57/0435; F16H 57/0412

(57) ABSTRACT

The present invention relates to a novel lubricating and cooling system for wind power generation gear box, comprising a motor pump, a connection portion, a filter, a cooler, a thermostatic valve, lines and necessary monitoring elements, accessories etc., characterized in that the novel lubricating and cooling system for wind power generation gear box adopts a novel control principle; during normal operation, the oil entering into the thermostatic valve is the cool oil cooled by the cooler, rather than the uncooled high-temperature oil, that is, the oil outlet port of the cooler 4 is connected to the high-temperature port B of the thermostatic valve 5, or directly connected to the oil outlet port C of the thermostatic valve 5 (directly entering into the gear box).

### TECHNICAL FIELD

The present invention relates to the field of hydraulic technology and new energy, and more particularly, to a thermostatic valve of a lubricating and cooling system for wind power generation gear box.

### BACKGROUND ART

After many years of use, the domestic wind power production apparatus is gradually exposing deficiencies in its original design during operation. For example the lubricating and cooling system for wind power generation gear box: most of domestic manufacturers are modeled on foreign homogeneous products, lack of innovation, but their production processes and equipment lag behind that of foreign manufacturers; therefore, the failure rate of the lubricating and cooling system for gear box produced by domestic manufacturers remains so high for years. Especially the thermostatic valve in the lubricating system, although the domestic and foreign lubricating system manufacturers use the same brand of thermostatic valve, failure often occurs in the thermostatic valve of the lubricating system manufactured by domestic manufacturers. High failure rate results in frequent shutdown of the gear box because of high temperature, causing economic losses for wind field. However, there is not yet a mature product to replace the thermostatic valve in the lubrication and cooling system.

The existing thermostatic valve of lubricating system for wind power generation gear box is directly mounted at the bottom of the filter (at the oil outlet port of the filter). When the oil temperature is lower than the temperature at which the low-temperature port of the thermostatic valve is closed (generally 60 degrees), the oil is divided into two branches, one directly entering into the gear box and the other flowing into the gear box through the cooler. When the oil temperature is higher than the temperature at which the low-temperature port of the thermostatic valve is closed, all the oil enters into the gear box after being cooled by the cooler. This mounting method is derived from foreign design, and almost all the lubricating system manufacturers utilize this principle.

When the gear box is operated normally, the oil will keep at high-temperature state (with the highest oil temperature at 80 degrees). Since the high-temperature oil will directly enters into the thermostatic valve if the thermostatic valve is directly mounted to the filter, the bulb of the thermostatic valve will be maintained in overload state and the thermostatic valve will be operated in high-temperature state for a long period, which will largely decrease the lifetime of the thermostatic valve. In order to keep the bulb of the thermostatic valve in normal load state, it must be operated within a reasonable temperature range; therefore, the oil entering into the thermostatic valve must be maintained around its operating temperature, so that the lifetime of the thermostatic valve will return back to the reasonable range.

### SUMMARY OF THE INVENTION

In order to address the above-mentioned deficiencies of the prior art, the object of the present invention is to provide a novel lubricating and cooling system for wind power generation gear box, which has a simple structure and unique principle, and can efficiently extend the lifetime of the thermostatic valve.

The present invention adopts the following technical solution: A novel lubricating and cooling system for wind power generation gear box is provided, which comprises a motor pump, a filter, a cooler and a thermostatic valve. It is characterized in that an outlet of the motor pump is connected to an oil inlet port of the filter; an oil outlet port E of the filter is connected to a low-temperature port A of the thermostatic valve, while an oil outlet port F of the filter is connected to an inlet of the filter; and an outlet of the cooler is connected to the high-temperature port B of the thermostatic valve, or directly connected to an outlet C of the thermostatic valve.

When the low-temperature port A of the thermostatic valve is closed, the oil flowing into the high-temperature port B of the thermostatic valve is the low-temperature oil cooled by the cooler.

The oil outlet port E of the filter is connected to the low-temperature port A of the thermostatic valve and communicates with the outlet C of the thermostatic valve in sequence.

The outlet C the thermostatic valve is connected to the distributor of the gear box.

All the oil ports of the thermostatic valve are connected to adjacent components in a rigid manner or via lines.

The thermostatic valve is mounted within the filter or the cooler.

When the thermostatic valve is mounted within the filter, the oil outlet port F of the filter is connected to the outlet C of the thermostatic valve and communicates with the low-temperature port A of the thermostatic valve in sequence, that is the oil outlet port F of the filter communicates with the low-temperature port A of the thermostatic valve.

The present invention has the following beneficial effects: According to the present invention, the position of the thermostatic valve 5 is adjusted by utilizing the above-mentioned novel principle and mounting method, so that the oil entering into the thermostatic valve 5 is low-temperature oil cooled by the cooler, rather than the high-temperature oil; therefore, the working environment of the thermostatic valve 5 is improved and the reliability thereof is significantly increased.

### BRIEF DESCRIPTION OF THE DRAWINGS

FIG. 1 is a principle diagram of a first embodiment of the present invention;

FIG. 2 is a principle diagram of a second embodiment of the present invention;

FIG. 3 is a principle diagram of a third embodiment of the present invention;

FIG. 4 is a principle diagram of a fourth embodiment of the present invention;

FIG. 5 is a principle diagram of a fifth embodiment of the present invention (integrating the thermostatic valve with the cooler); and

FIG. 6 is a principle diagram of a sixth embodiment of the present invention (integrating the thermostatic valve with the filter).

### DETAILED DESCRIPTION OF THE INVENTION

The present invention will now be further described below with reference to the accompanying drawings. The present invention comprises a motor pump 1, a filter 3, a cooler 4 and a thermostatic valve 5, wherein, the outlet of the motor pump 1 is connected to an oil inlet port of the filter 3; an oil outlet port E of the filter 3 is connected to a low-temperature port A of the thermostatic valve 5, while an oil outlet port F of the filter 3 is connected to an inlet of the cooler 4; and an outlet of the cooler 4 is connected to a high-temperature port B of the thermostatic valve 5, or directly connected to an outlet C of the thermostatic valve 5. When the low-temperature port A of the thermostatic valve 5 is closed, the oil flowing into the high-temperature port B of the thermostatic valve 5 is the low-temperature oil cooled by the cooler 4. The oil outlet port E of the filter 3 is connected to the low-temperature port A of the thermostatic valve 5 and communicates with the outlet C of the thermostatic valve 5 in sequence. The outlet C of the thermostatic valve 5 is connected to the distributor of the gear box. All the oil ports of the thermostatic valve 5 are connected to adjacent components in a rigid manner or via lines. The thermostatic valve 5 may be mounted within the filter 3 or the cooler 4. When the thermostatic valve 5 is mounted within the filter 3, the oil outlet port F of the filter 3 is connected to the outlet C of the thermostatic valve 5 and communicates with the low-temperature port A of the thermostatic valve 5 in sequence, that is, the oil outlet port F of the filter 3 communicates with the low-temperature port A of the thermostatic valve 5.

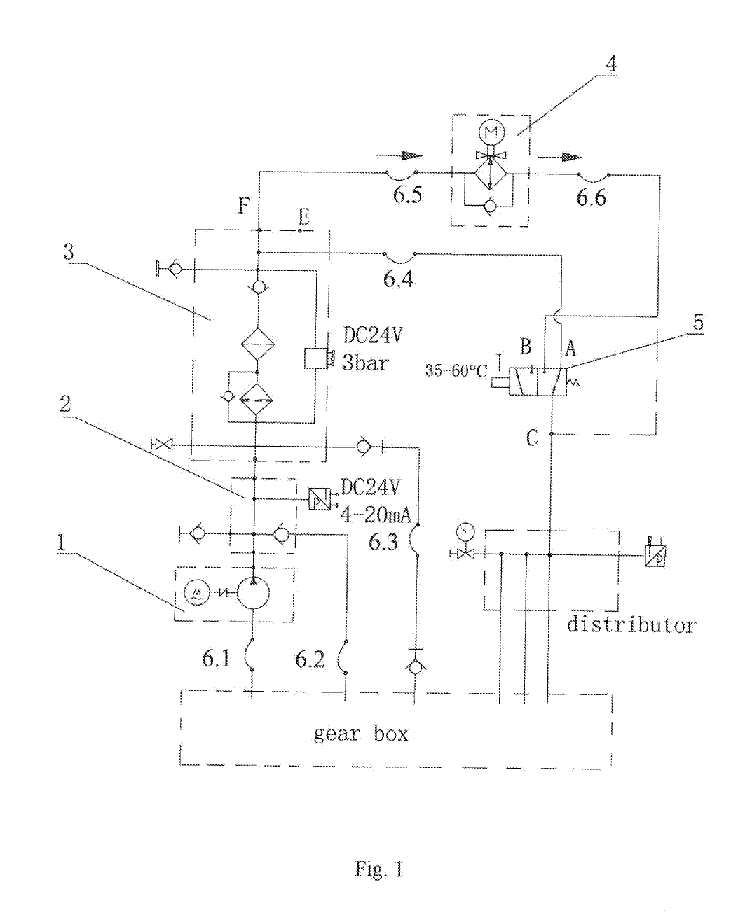

As shown in FIG. 1, a novel lubricating and cooling system (device) for wind power generation gear box mainly comprises a motor pump 1, a connection portion 2, a filter 3, a cooler 4, a thermostatic valve 5, lines and necessary monitoring elements, accessories, etc.

As shown in FIG. 1, the oil pumped from the motor pump 1 enters into the filter 3 through the connection portion 2, and flows out from the oil outlet ports E and F of the filter 3 after being filtered, wherein the oil flowing out from the port E flows towards the low-temperature port A of the thermostatic valve 5, and then flows into the distributor of the gear box through the port C of the thermostatic valve 5; and the oil flowing out from the port F enters into the cooler 4, and then flows towards the port B (or port C) of the, thermostatic valve 5 and then into the distributor of the gear box.

As shown in FIG. 1, when the oil temperature is lower than the operating temperature (for example 45 degrees) of the thermostatic valve 5, most of the oil flows into the thermostatic valve 5 from the low-temperature port A of the thermostatic valve 5, and exits from the port C of the thermostatic valve; when the oil temperature is within the range of the operating temperature of the thermostatic valve 5 (for example 45-60 degrees), the flow rate of the two oil ports (A and B) change as the temperature rises, with the flow rate of the port A decreasing and that of the port B increasing; and when the oil temperature is higher than the operating temperature of the thermostatic valve 5 (for example 60 degrees), the port A is closed, and all the oil enters into the port B (or port C) of the thermostatic valve 5 after being cooled by the cooler 4.

As shown in FIG. 1, hoses connect the port E of the filter 3 and the port A of the thermostatic valve 5, connect the port F of the filter 3 and the oil inlet port of the cooler 4, and connect the oil outlet port of the cooler 4 and the port B (or port C) of the thermostatic valve 5, while the port C of the thermostatic valve 5 is directly connected to the distributor in a rigid manner (for example via transition joints).

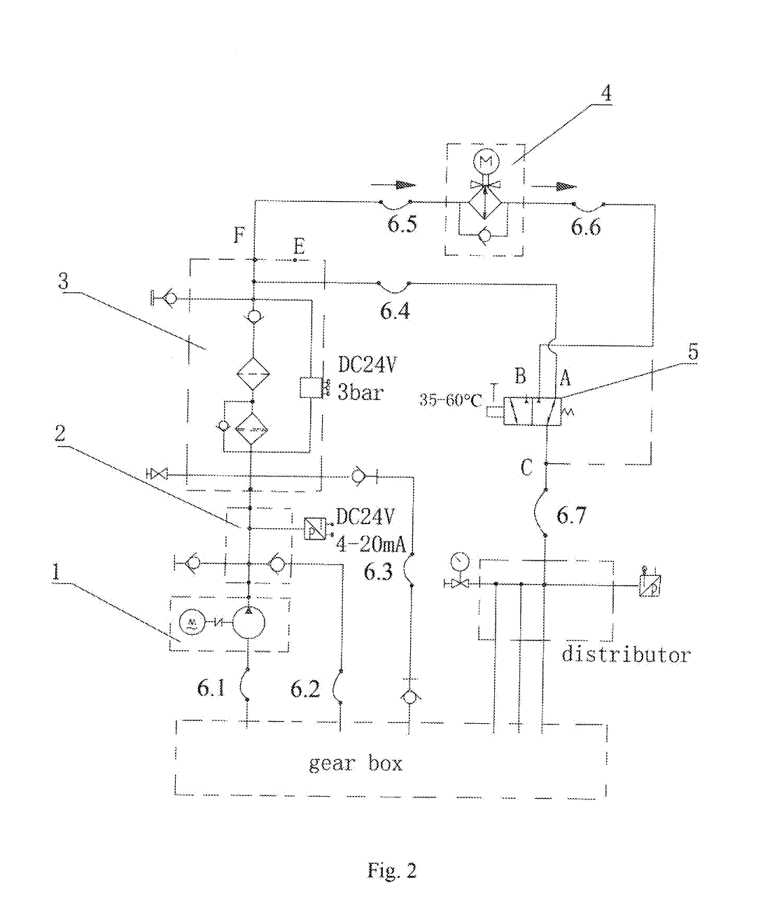

As shown in FIG. 2, a second embodiment of the present invention is similar to FIG. 1, except that the port C of the thermostatic valve 5 is connected to the distributor via hoses.

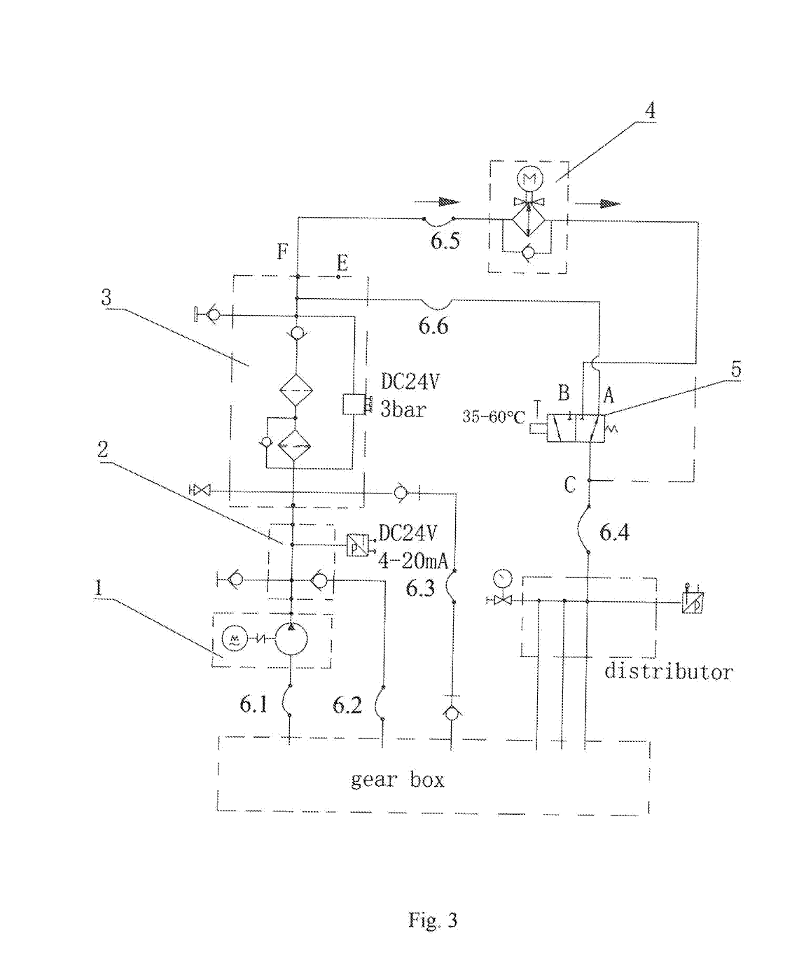

As shown in FIG. 3, a third embodiment of the present invention is similar to FIG. 2, except that the oil outlet port of the cooler 4 is connected to the port B (or port C) of the thermostatic valve 5 in a rigid manner (for example via transition joints).

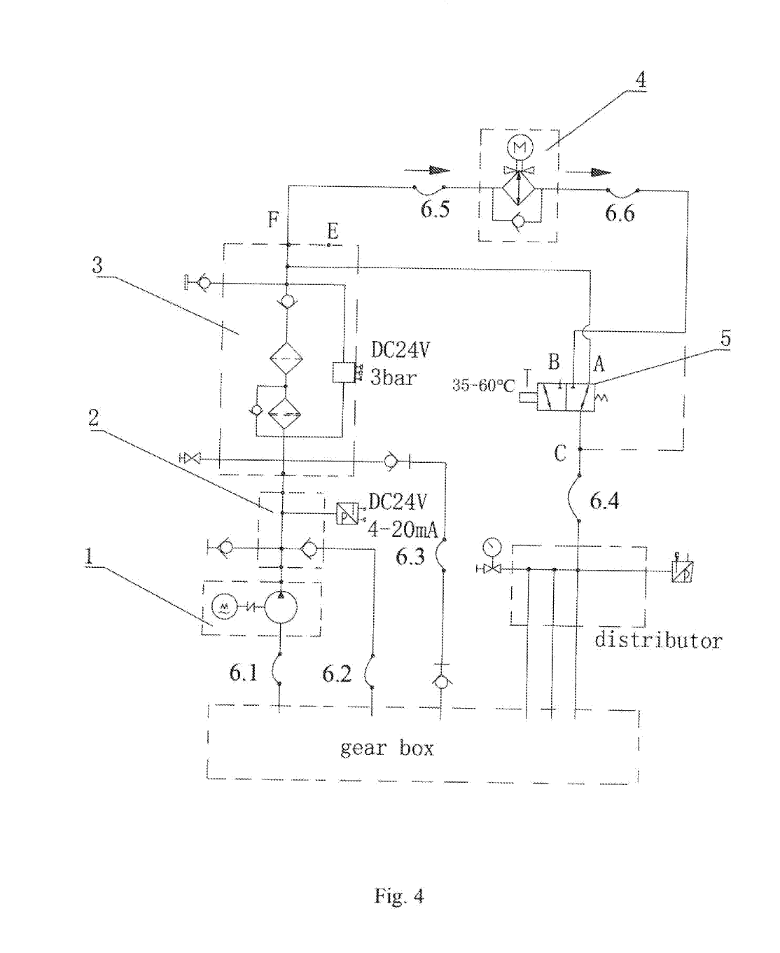

As shown in FIG. 4, a fourth embodiment of the present invention is similar to FIG. 2, except that the port A of the thermostatic valve 5 is connected to the port E of the filter 3 in a rigid manner (for example via transition joints).

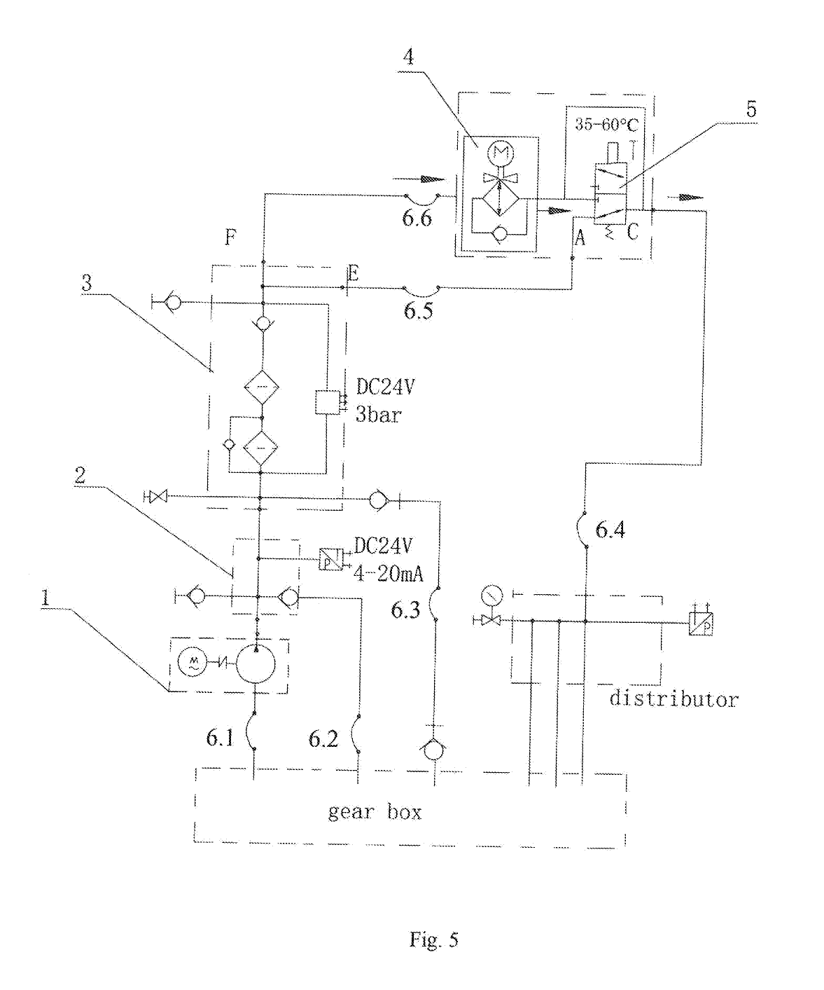

As shown in FIG. 5, a fifth embodiment of the present invention is similar to FIG. 3, except that the thermostatic valve 5 is mounted within the cooler 4 (integrated together).

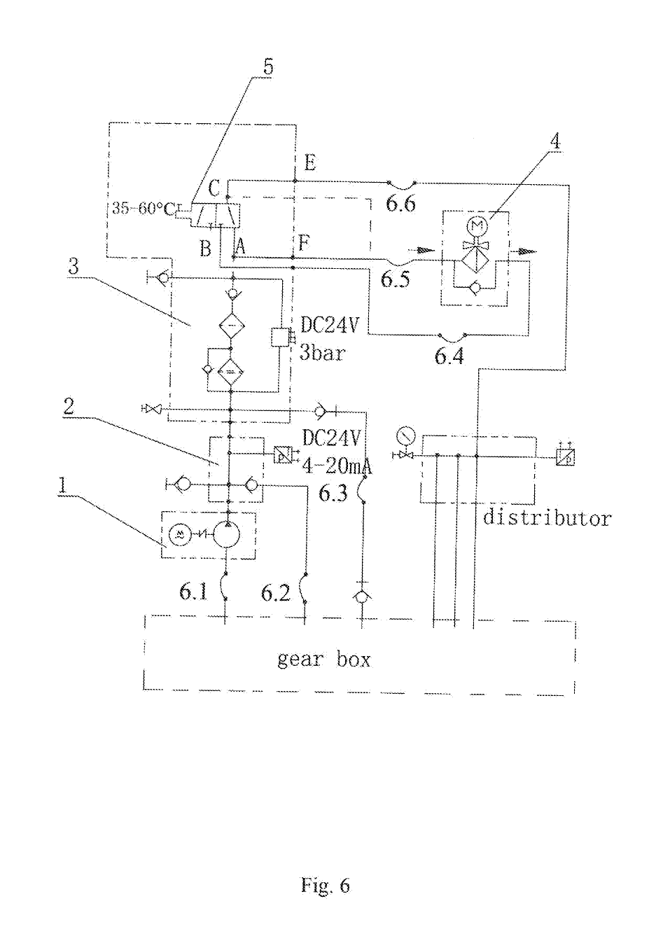

As shown in FIG. 6, in a sixth embodiment of the present invention, the oil pumped from the motor pump 1 enters into the filter 3 through the connection portion 2. One branch of the filtered oil flows into the thermostatic valve 5 from the low-temperature port A of the thermostatic valve, and then flows out from the port C of the thermostatic valve 5 and directly into the distributor of the gear box through the oil outlet port E of the filter 3; and the other branch of the filtered oil flows out from the port F of the filter and into the cooler 4, then flows towards the port B (or port C) of the thermostatic valve 5, and then directly enters into the distributor of the gear box from the port E of the filter.

As shown in FIG. 6, when the oil temperature is lower than the operating temperature (for example 45 degrees) of the thermostatic valve 5, most of the oil flows into the thermostatic valve 5 from the low-temperature port A of the thermostatic valve 5 to the port C thereof, and then flows to the port E of the filter 3; when the oil temperature is within the range of the operating temperature of the thermostatic valve 5 (for example 45-60 degrees), the flow rate of the two oil ports (A and B) change as the temperature rises with the flow rate of the port A decreasing and that of the port B increasing; and when the oil temperature is higher than the operating temperature of the thermostatic valve 5 (for example 60 degrees), the port A is closed, and all the oil enters into the thermostatic valve 5 through the port B (or port C) of the thermostatic valve 5 after being cooled by the cooler 4, and then flows into the distributor from the port E of the filter 3.

As shown in. FIG. 6, hoses connect the port F of the filter 3 and the oil inlet port of the cooler 4, and connect the oil outlet port of the cooler 4 and the port B (or port C) of the thermostatic valve 5, and the port E of the filter 3 is connected to the distributor via hoses.

Although the contents of the present invention have been described in detail with reference to the preferred embodiments described above, it should be recognized that the foregoing description should not be construed as limiting the invention, and that various modifications and alternatives of the present invention will become apparent to those skilled in the art after having read the above description; therefore, the scope of the present invention should be defined by the appended claims.

Other contents related to the present invention not described therein are identical to the prior art.

1. A novel lubricating and cooling system for wind power generation gear box, comprising a motor pump (1), a filter (3), a cooler (4) and a thermostatic valve (5), characterized in that an outlet of the motor pump (1) is connected to an oil inlet port of the filter (3); an oil outlet port E of the filter (3) is connected to an low-temperature port A of the thermostatic valve (5), while an oil outlet port F of the filter (3) is connected to the inlet of the cooler (4); and an outlet of the cooler (4) is connected to a high-temperature port B of the thermostatic valve (5), or directly connected to the an outlet C of the thermostatic valve (5).

2. The novel lubricating and cooling system for wind power generation gear box according to claim 1, characterized in that after the low-temperature port A of the thermostatic valve (5) is closed, the oil entering into the high-temperature port B of the thermostatic valve (5) is the low-temperature oil cooled by the cooler (4).

3. The novel lubricating and cooling system for wind power generation gear box according to claim 1, characterized in that the oil outlet port E of the filter (3) is connected to the low-temperature port A of the thermostatic valve (5) and communicates with the outlet C of the thermostatic valve (5) in sequence.

4. The novel lubricating and cooling system for wind power generation gear box according to claim 1, characterized in that the outlet C of the thermostatic valve (5) is connected to a distributor of the gear box.

5. The novel lubricating and cooling system for wind power generation gear box according to claim 1, characterized in that all the oil ports of the thermostatic valve (5) are connected to adjacent components in a rigid manner or via lines.

6. The novel lubricating and cooling system for wind power generation gear box according to claim 1, characterized in that the thermostatic valve (5) is mounted within the filter (3) or the cooler (4).

7. The novel lubricating and cooling system for wind power generation gear box according to claim 6, Characterized in that when the thermostatic valve (5) is mounted within the filter (3), an oil outlet port F of the filter (3) is connected to an outlet C of the thermostatic valve (5) and communicates with a low-temperature port A of the thermostatic valve (5) in sequence, that is, the oil outlet port F of the filter (3) communicates with the low-temperature port A of the thermostatic valve (5).
